(19) United States
(12) Patent Application Publication
(10) Pub. No.: US 2026/0097911 A1
(43) Pub. Date: Apr. 9, 2026

(54) Dunnage Separation System and Related Methods

(71) Applicant: Android Industries LLC, Auburn Hills, MI (US)

(72) Inventors: Ufuk Suadiye, Izmit (TR); Ahmet Isik, Kocaeli (TR); John E. Donnay, West Bloomfield, MI (US); Joshua James Hicks, Grand Blanc, MI (US)

(21) Appl. No.: 19/352,931

(22) Filed: Oct. 8, 2025

Related U.S. Application Data
(60) Provisional application No. 63/705,101, filed on Oct. 9, 2024.

(51) Int. Cl. B65G 59/00; B65B 69/00; B65G 47/90; B65G 57/03; B65G 59/02

(52) U.S. Cl. CPC B65G 59/005; B65B 69/00; B65G 47/905; B65G 57/035; B65G 59/023

(57) ABSTRACT

An end effector includes a base, a first leg, a second leg, a first arm, and a second arm. The first leg is connected to the base. The second leg is connected to the base and is offset from the first leg. The first arm is pivotably connected to the first leg. The second arm is pivotably connected to the second leg. The first leg and the first arm are configured to releasably hold a first portion of a dunnage unit. The second leg and the second arm are configured to releasably hold a second portion of the dunnage unit.

### CROSS-REFERENCE TO RELATED APPLICATIONS

This application claims the benefit of U.S. Provisional Application No. 63/705,101 filed Oct. 9, 2024, the entire disclosure of which is incorporated herein by reference.

### FIELD

The present disclosure relates to a dunnage separation system.

### BACKGROUND

Conventional dunnage separation systems typically involve specialized equipment and manual labor. The specialized equipment may have limited versatility and may not be suitable for removing certain types of dunnage units from goods or for separating layers of a used dunnage unit such that the layers can be recycled or reused. Manual labor for removing dunnage units from goods or for separating layers of used dunnage units can be time-consuming and physically demanding, which may lead to inefficiencies and worker fatigue or injury. While known dunnage separation systems have proven acceptable for their intended purpose, a continuous need for improvement remains in the art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides an end effector. The end effector includes a base, a first leg, a second leg, a first arm, and a second arm. The first leg is connected to the base. The second leg is connected to the base and is offset from the first leg. The first arm is pivotably connected to the first leg. The second arm is pivotably connected to the second leg. The first leg and the first arm are configured to releasably hold a first portion of a dunnage unit. The second leg and the second arm are configured to releasably hold a second portion of the dunnage unit.

Another aspect of the disclosure provides a method for operating an end effector. The method includes engaging the end effector with a dunnage unit. The dunnage unit is disposed on a good. The dunnage unit includes an inner layer disposed between two outer layers. The method includes moving a first arm, a second arm, and a third arm of the end effector from an open configuration to a closed configuration such that the dunnage unit is secured to the end effector. The method includes removing, by the end effector, the dunnage unit from the good. The method includes disposing, by the end effector, the dunnage unit on a staging system. The method includes moving the third arm to the open configuration such that the inner layer is unsecured to the end effector. The method includes moving the end effector away from the staging system such that the inner layer separates from the outer layers.

Yet another aspect of the disclosure provides a rope system. The rope system includes a set of ropes and a platform. The set of ropes each have a first end and a second end. The set of ropes is configured to support a dunnage unit. The first end is connected to a first end of a frame. The second end is connected to a second end of the frame. The platform has at least a portion protruding from the set of ropes and is configured to move between the first end of the frame and the second end of the frame. The rope system is configured to move the dunnage unit from a first location to a second location.

Another aspect of the disclosure provides a method for operating a rope system. The method includes disposing a dunnage unit onto a platform and a set of ropes. The method includes moving, by the platform, the dunnage unit from a first location to a second location along the set of ropes. The method includes detaching, by the set of ropes, the dunnage unit from the platform, wherein the set of ropes define an angle relative to the platform proximate the second location.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example dunnage separation system in accordance with the principles of the present disclosure.

FIG. 2 is a perspective view of an example end effector system of the dunnage separation system in accordance with the principles of the present disclosure.

FIG. 3 is a perspective view of an example dunnage unit in accordance with the principles of the present disclosure.

FIG. 4A-4P are perspective views depicting example operations of a dunnage separation system in accordance with the principles of the present disclosure.

FIG. 4Q-4R are perspective views depicting example operations of another dunnage separation system in accordance with the principles of the present disclosure.

FIGS. 5 and 6 are flowcharts depicting example methods for operating the dunnage separation system in accordance with the principles of the present disclosure.

In the drawings, reference numbers may be reused to identify similar and/or identical elements.

### DETAILED DESCRIPTION

### Introduction

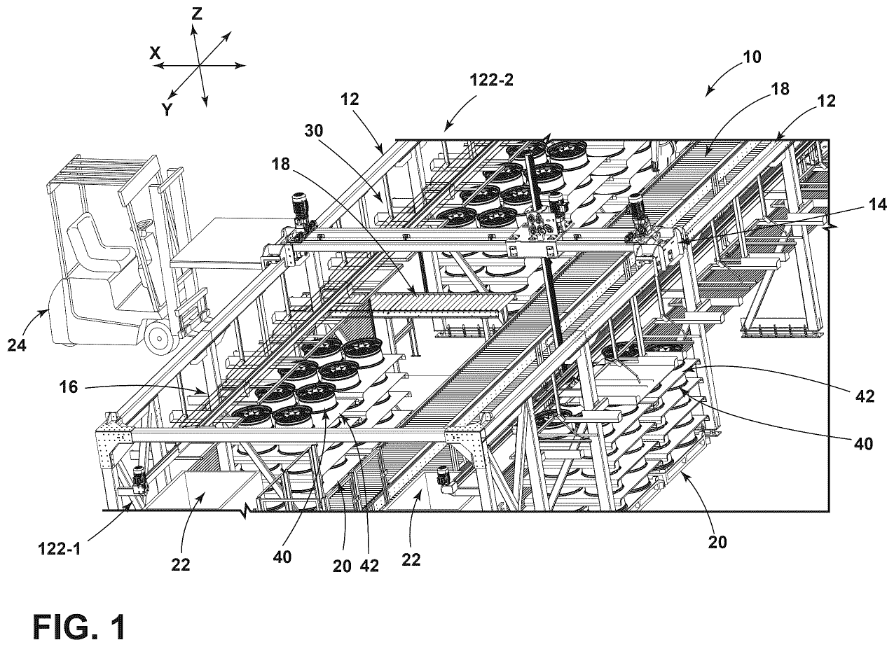

With reference to FIG. 1, an example dunnage separation system 10 is shown. As will be explained in more detail below, the system 10 may include a frame 12, an end effector system 14, a rope system 16, a set of conveyors 18, a set of staging systems 20, at least one recycling system 22 (e.g., a recycling bin, etc.), and/or at least one machine 24 (e.g., a robot, a forklift, etc.), among others.

In various implementations, the frame 12 comprises one or more of a variety of shapes, sizes, configurations, and/or materials. The end effector system 14 may be slidably connected to the frame 12. The rope system 16 may be connected to the frame 12. In various implementations, the frame 12 defines an opening 30. In some example configurations, the conveyors 18, the staging system 20, and/or the recycling system 22 are at least partially disposed in the opening 30. In various implementations, the machine 24 moves about the frame 12 and within the opening 30. In various implementations, a staging system 20 includes a stand, a shelf, a pallet, a rack, a lift, a cart (e.g., motorized cart), and/or a stage, among others.

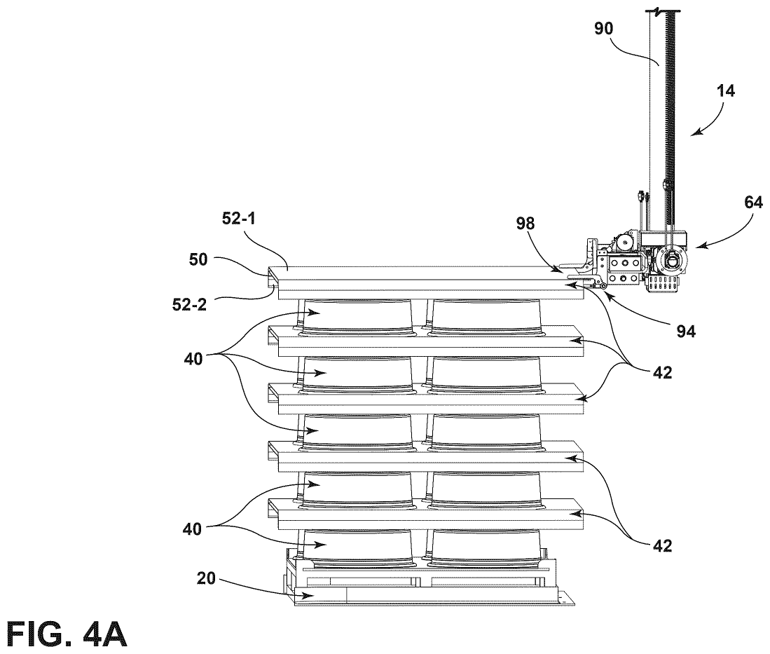

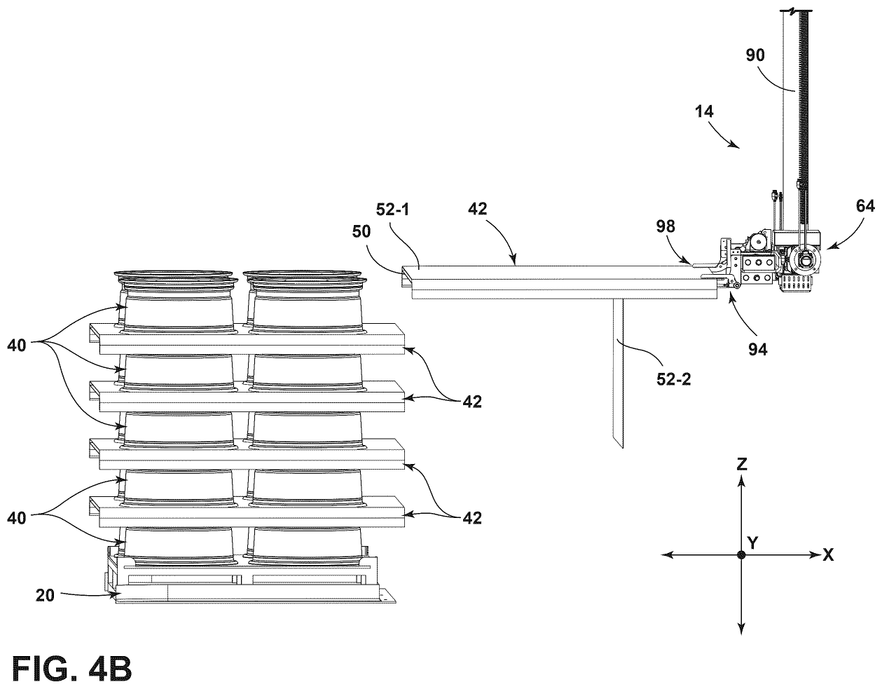

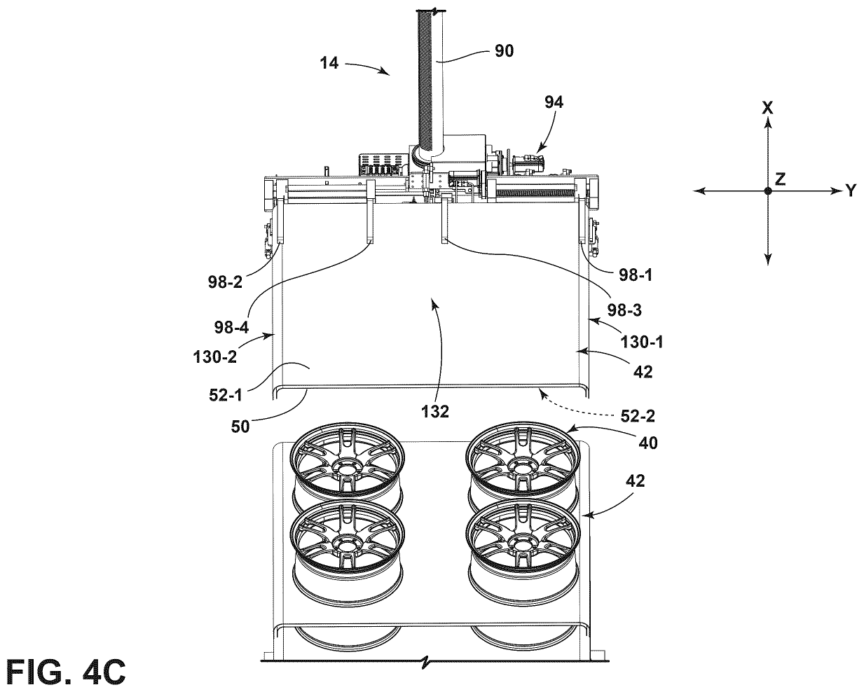

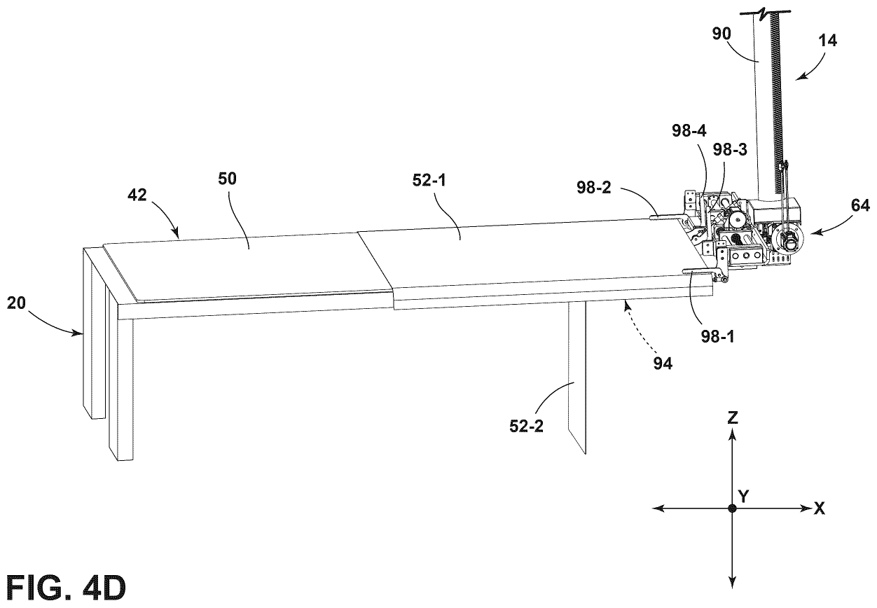

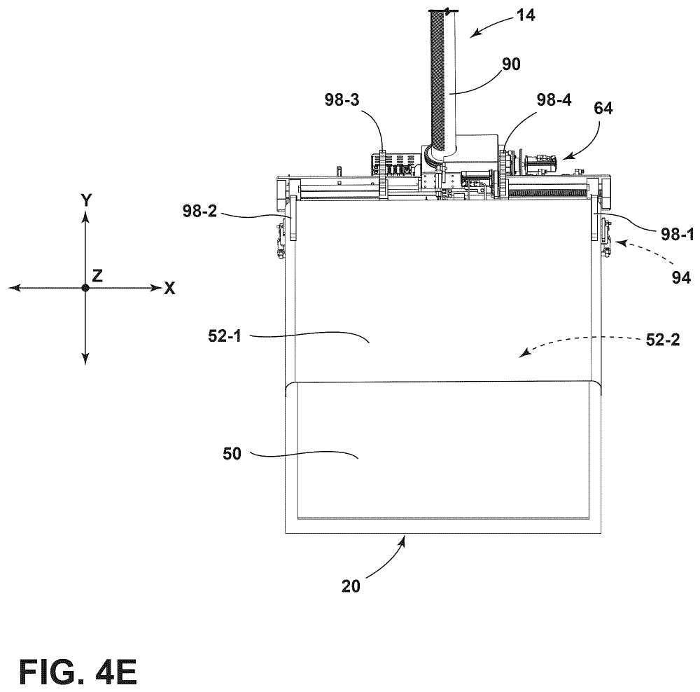

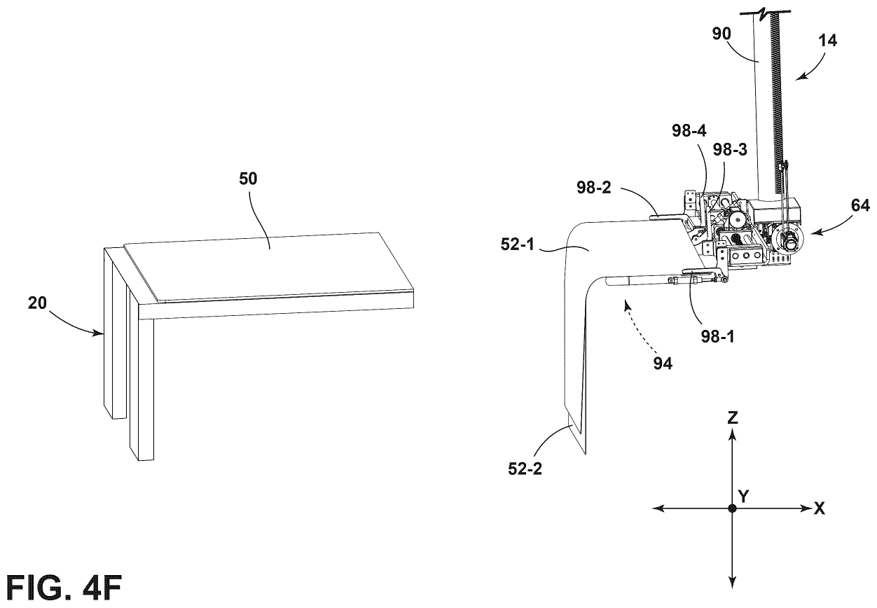

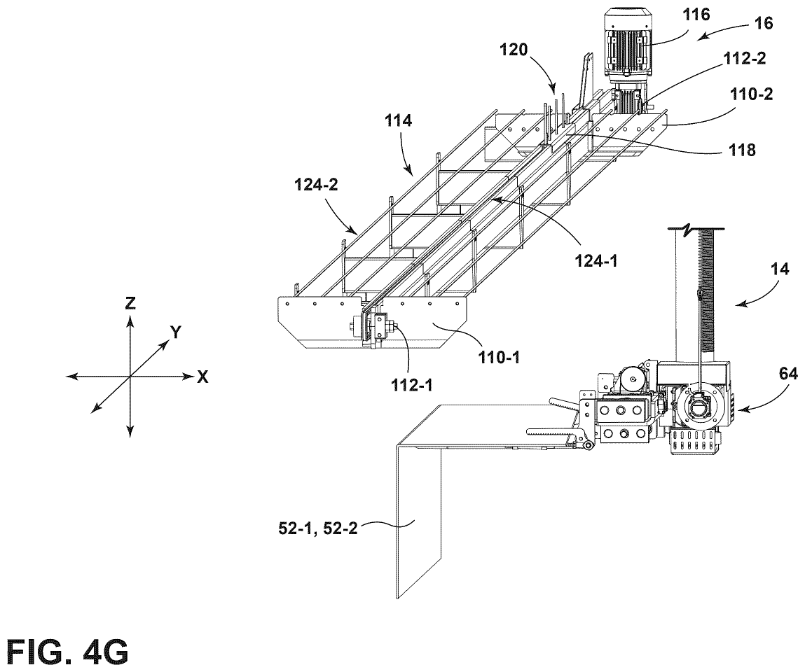

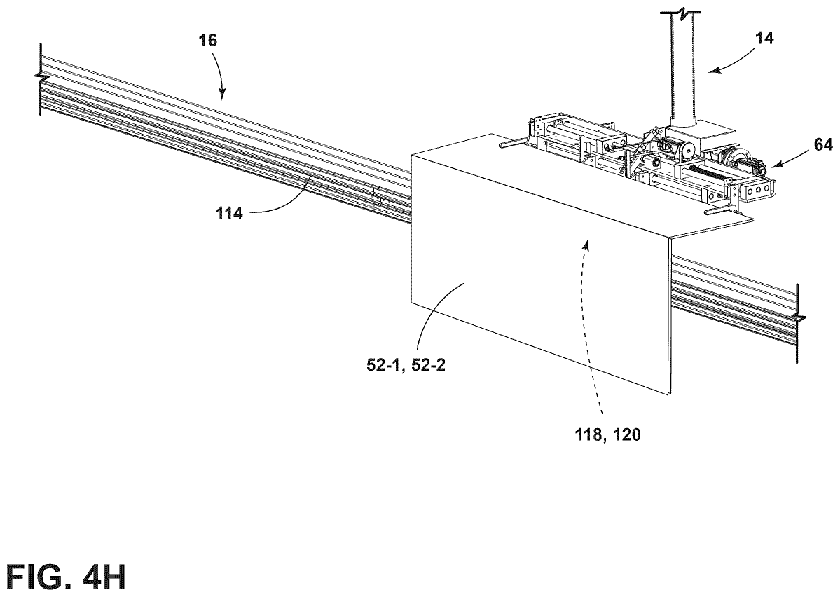

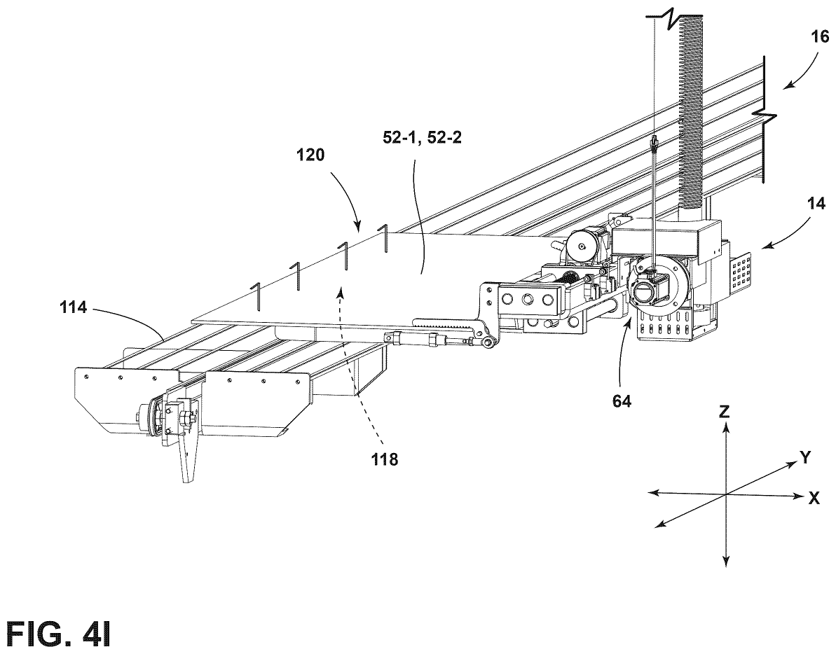

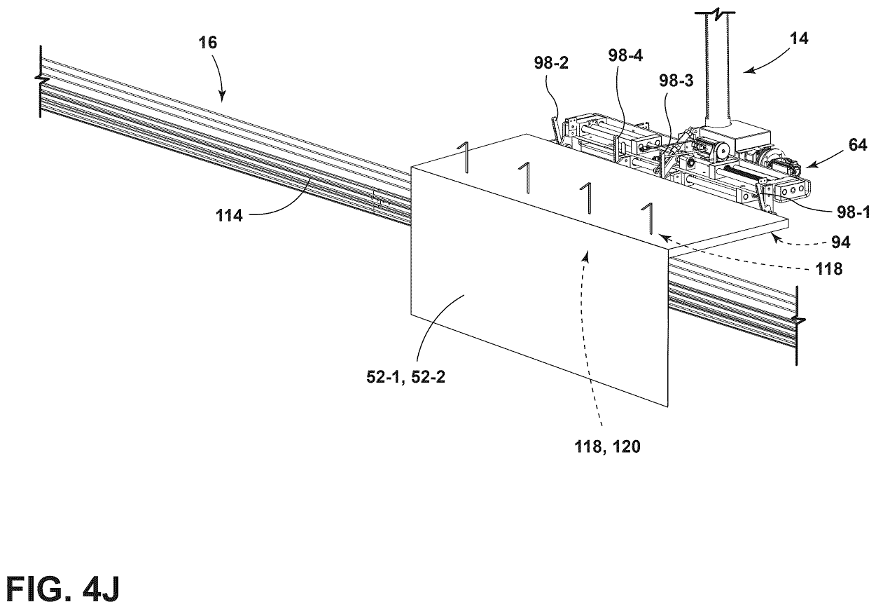

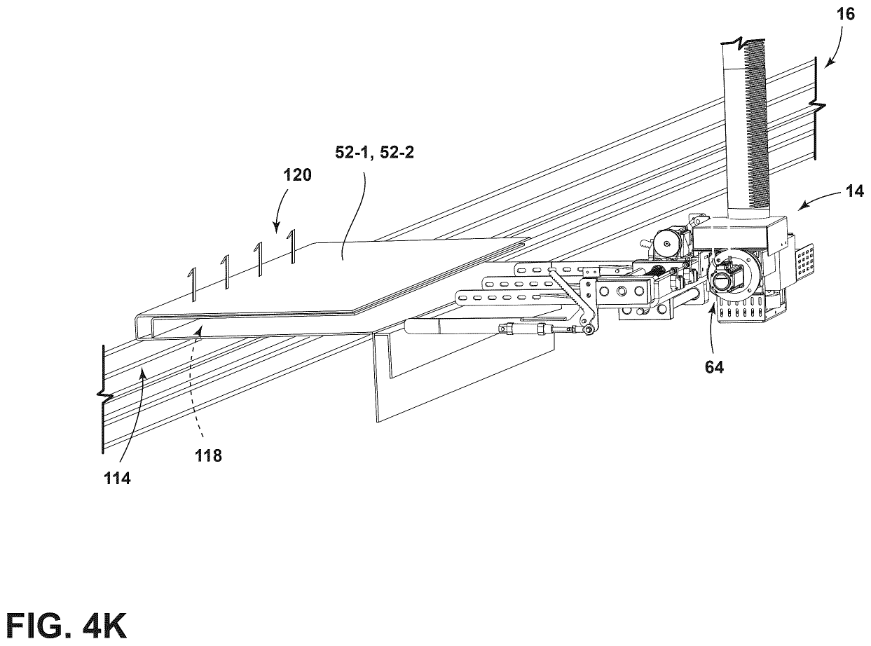

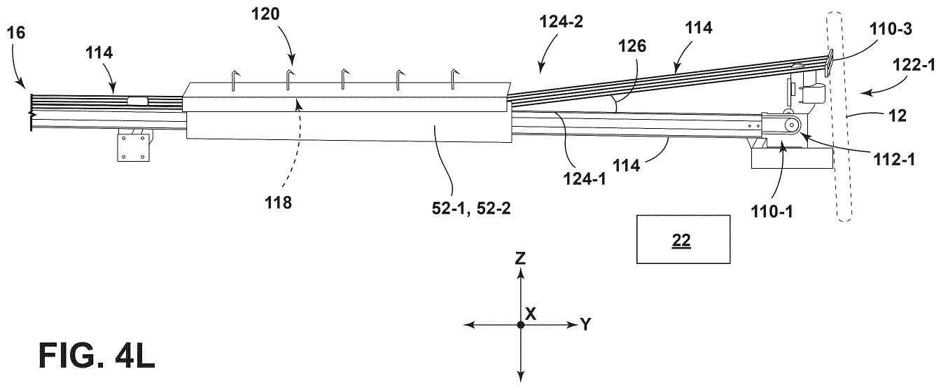

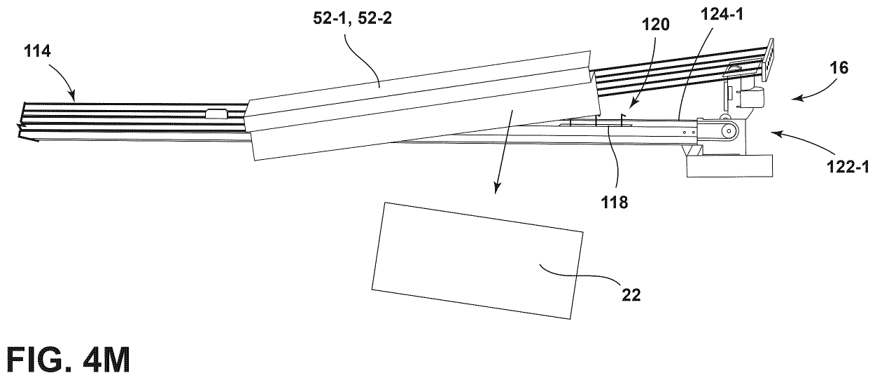

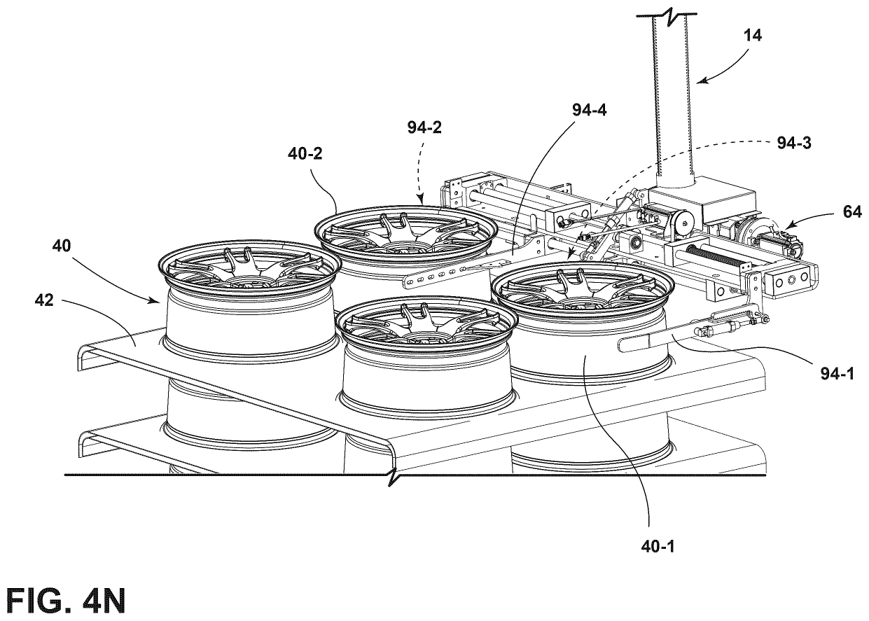

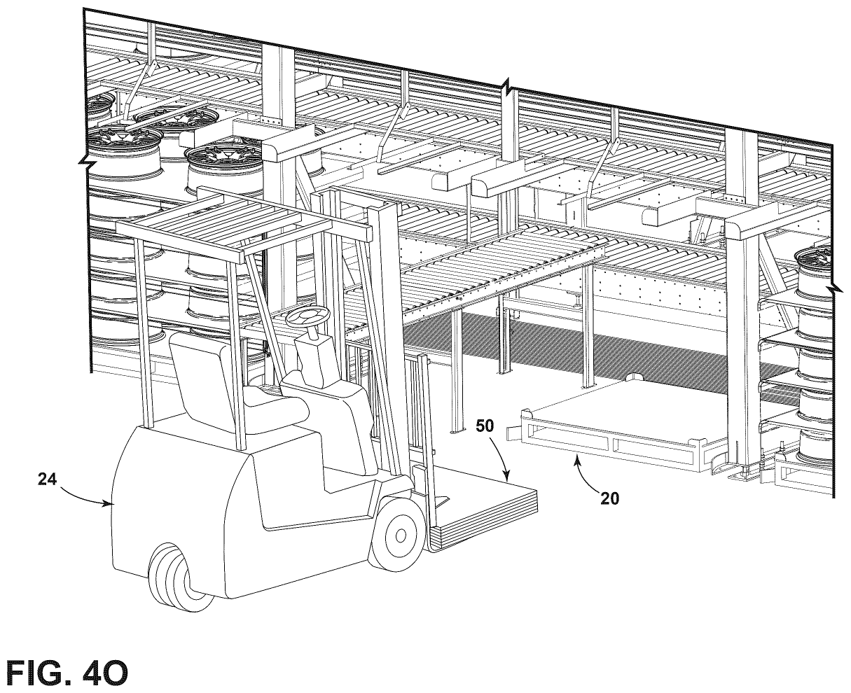

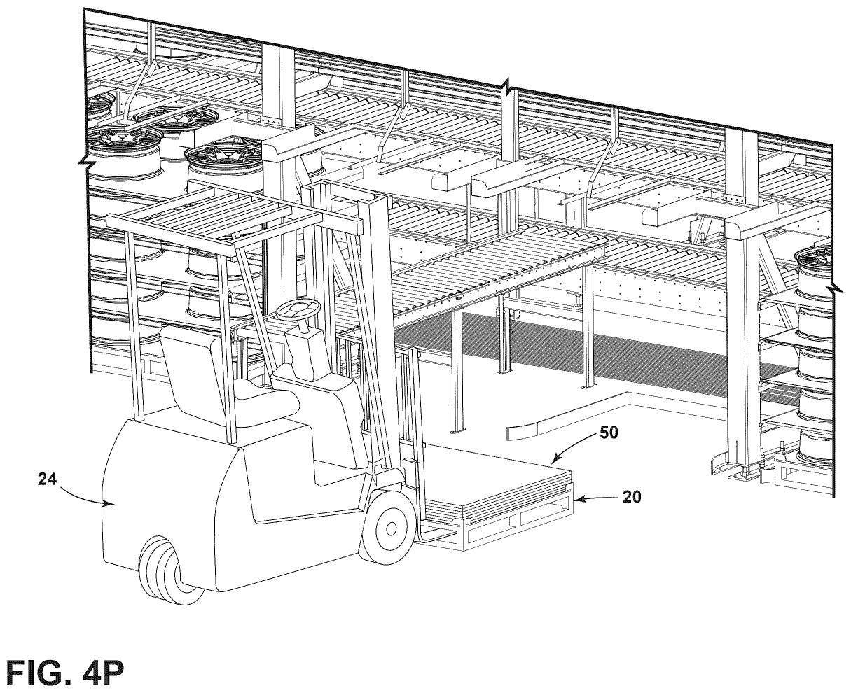

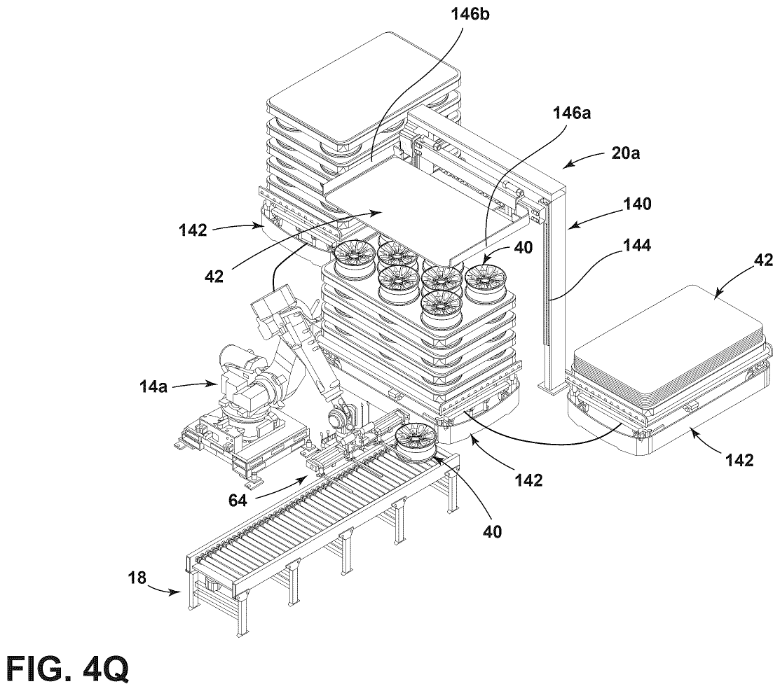

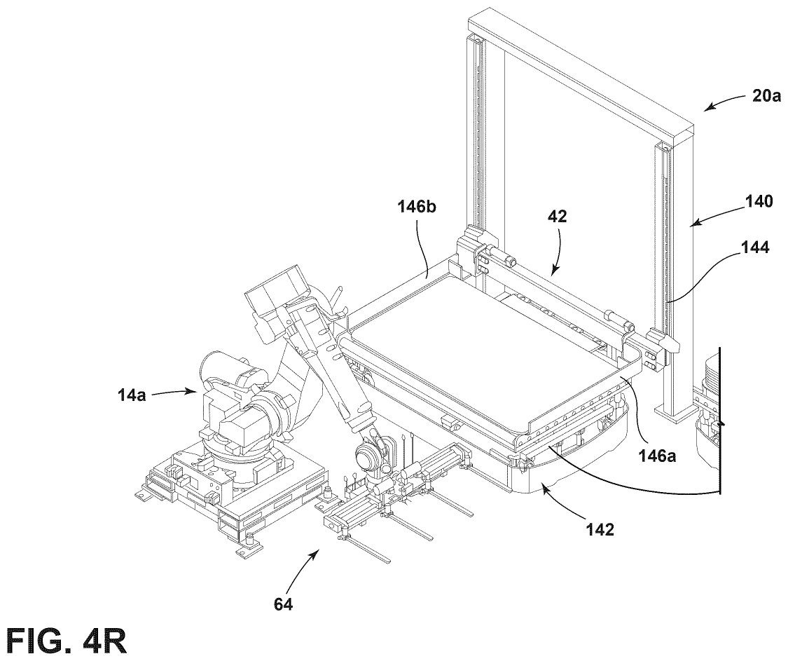

Referring now to FIGS. 1 and 4A, in various implementations, a set of goods 40 (e.g., wheels, tires, products, devices, materials, etc.) is disposed (e.g., stacked) on the staging system 20. In various implementations, a set of dunnage units 42 engages and/or covers the set of goods 40. For example, each unit of the set of dunnage units 42 may engage and/or cover at least portions of one or more goods.

In various implementation, each unit 42 protects one or more goods 40 from incurring damage during transport and/or storage. For example, each unit prevents the goods from incurring scratches. Each unit stabilizes the goods by absorbing shocks and vibrations experienced by the goods.

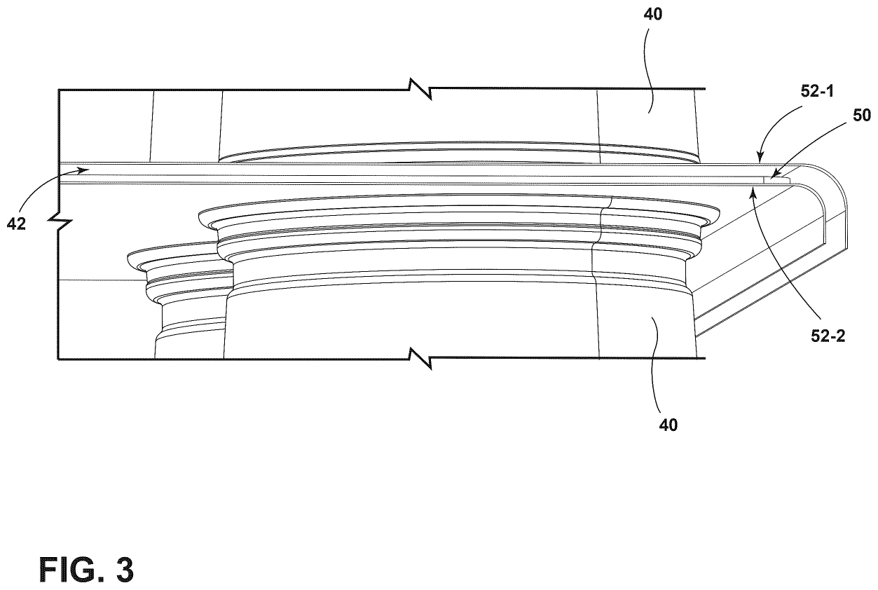

With reference to FIG. 3, in various implementations, each unit 42 comprises one or more of a variety of shapes, sizes, configurations, and/or materials. In some example configuration, each unit 42 includes at least one inner layer 50, a first outer layer 52-1, and a second outer layer 52-2. The inner layer 50 may be disposed between the first outer layer 52-1 and the second outer layer 52-2. In various implementations, the first outer layer 52-1 and/or the second outer layer 52-1 may be removably connected to the inner layer 50. As shown in FIG. 3, the first and second outer layers 52-1, 52-2 may be larger (e.g., include a larger surface area) than the inner layer 50. For instance, portions of the first and second outer layers 52-1, 52-2 may extend beyond the inner layer 50.

In various implementations, the inner layer 50 comprises a rigid material (e.g., metal, plastic, foam, wood, etc.). In various implementations, the first outer layer 52-1 and the second outer layer 52-2 comprise a foam material and/or a plastic material, among others. The first outer layer 52-1 and the second outer layer 54B may be softer (e.g., comprise a lower durometer, etc.) than the inner layer 50. In various implementations, the first outer layer 52-1 and the second outer layer 52-2 engage portions of one or more goods 40. The first outer layer 52-1 and the second outer layer 52-2 prevent the goods from incurring scratches.

As will be explained in more detail below, the system 10 removes (e.g., detaches) each unit of the set of units 42 from the set of goods 40. For each unit 42 that has been removed from the goods, the system 10 may separate the first outer layer 52-1 and the second outer layer 52-2 from the inner layer 50 (e.g., via the end effector system 14). The system 10 may transport (e.g., via the rope system 16, etc.) the first outer layer 52-1 and the second outer layer 52 to a recycling system 22 such that the first outer layer 52-1 and the second outer layer 52-2 can be recycled. The system 10 may transport the inner layer 50 to a determined location (e.g., a staging system 20) such that all of the inner layers 50 from used dunnage units 42 can be collected. In some examples, the collected inner layers 50 may be reused for new dunnage units.

In various implementations, in response to the system 10 removing a unit 42 from one or more goods 40, the system 10 transports the goods to a determined location (e.g., a staging system 20) such that the goods can undergo additional operations. For example, the end effector system 14 and/or the machine 24 may place the goods on a conveyor 18 and/or may move the goods to the determined location.

### End Effector System

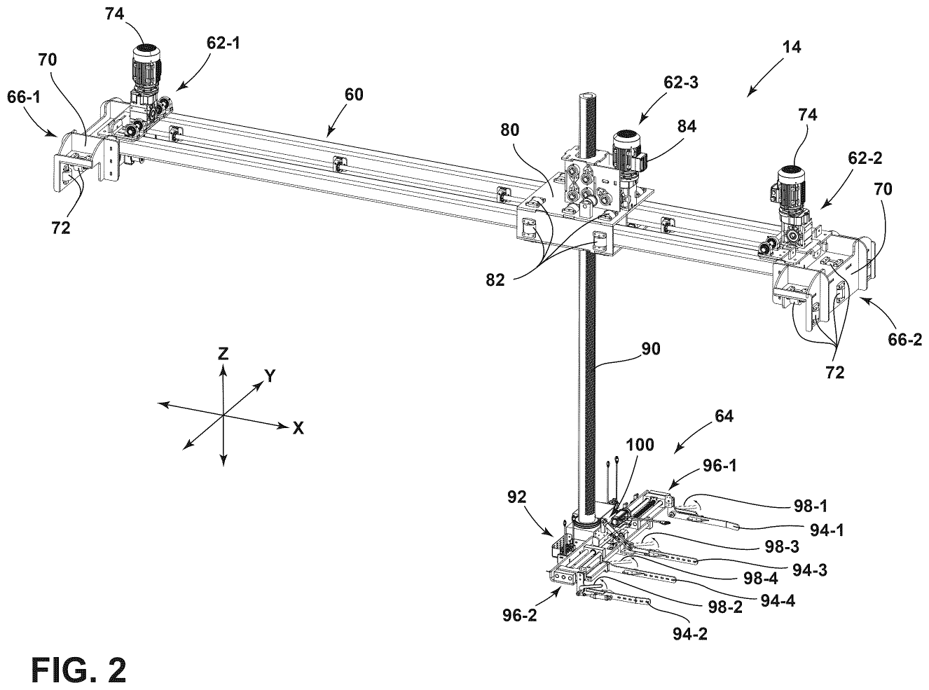

With reference to FIG. 2, an example end effector system 14 is shown. In various implementations, the end effector system 14 includes a track 60, a first motor assembly 62-1, a second motor assembly 62-2, a third motor assembly 62-3, an end effector 64, and/or a controller (not depicted), among others.

In some example configurations, the first motor assembly 62-1 is connected to a first end 66-1 of the track 60. The first motor assembly may be slidably connected to the frame 12. The second motor assembly 62-2 may be connected to a second end 66-2 of the track 60. The second motor assembly 62-2 may be slidably connected to the frame 12. In various implementations, the first motor assembly 62-1 and the second motor assembly 62-2 move the track 60, and the components attached thereto (e.g., the third motor assembly 62-3 and the end effector 64), relative to the frame 12 (e.g., in the Y-direction).

In various implementations, the first motor assembly 62-1 and the second motor assembly 62-2 each include a bracket 70, a set of wheels 72, and a motor 74. The set of wheels 72 may be rotatably connected to the bracket 70. The motor 74 may be connected to the bracket 70 and may be at least indirectly connected to the wheels 72. The motor 74 may drive the rotation of the wheels 72 such that the first and second motor assemblies 62-1, 62-2 may drive the movement of the track 60 relative to the frame 12.

In various implementations, the third motor assembly 62-3 is slidably connected to the track 60. The third motor assembly 62-3 may be disposed between the first motor assembly 62-1 and the second motor assembly 62-2. In various implementations, the third motor assembly 62-3 moves relative to the track 60 (e.g., in the X-direction). While the end effector system 14 is generally shown and described herein as including three motor assemblies 62, the end effector system 14 may include more or less than three motor assemblies 62 within the scope of the present disclosure.

In various implementations, the third motor assembly 62-3 includes a bracket 80, a set of wheels 82, and a motor 84. The set of wheels 82 may be rotatably connected to the bracket 80. The motor 84 may be connected to the bracket 80 and may be at least indirectly connected to the wheels 82. The motor 84 may drive the rotation of the wheels 82 such that the third motor assembly 62-3 may move relative to the track 60.

In various implementations, the end effector 64 is indirectly connected to the third motor assembly 62-3, for example, by an elongated structure 90. In various implementations, the third motor assembly 62-3 (e.g., a subset of the set of wheels 82 and the motor 84 or an additional motor) move (e.g., in the Z-direction) the end effector 64 and the elongated structure 90 relative to the track 60.

In various implementations, the end effector 64 comprises one or more of a variety of shapes, sizes, configurations, and/or materials. In some example configurations, the end effector 64 includes a base 92, a first leg 94-1, a second leg 94-1, a third leg 94-3, and a fourth leg 94-4.

In various implementations, the base 92 is connected to the structure 90. The base 92 may include an elongated-shaped configuration. The legs 94-1, 94-2, 94-3, 94-4 may be adjustably connected to the base 92 and offset from one another. For example, the legs 94-1, 94-2, 94-3, 94-4 may be slidably-coupled to the base 92 for translation in a Y-direction such that the distances between the legs 94-1, 94-2, 94-3, 94-4 in the Y-direction can be increased or decreased by a driver (e.g., a motor). In some examples, the first leg 94-1 is disposed proximate a first end 96-1 of the base 92. The second leg 94-2 is disposed proximate a second end 96-2 of the base 92. The third leg 94-3 and the fourth leg 94-4 are disposed between the first leg 94-1 and the second leg 94-2.

In various implementations, the legs 94-1, 94-2, 94-3, 94-4 each include an arm 98. Each arm 98 may be pivotably connected to a respective leg 94 for rotation about an axis extending in the Y-direction. For example, a first arm 98-1 may be pivotably connected to the first leg 94-1, a second arm 98-2 may be pivotably connected to the second leg 94-2, a third arm 98-3 may be pivotably connected to the third leg 94-3, and a fourth arm 98-4 may be pivotably connected to the fourth leg 94-4.

In various implementations, each arm 98 moves (e.g., pivots) between an open configuration to a closed configuration to releasably grasp (e.g., hold) at least portions of a good 40 and/or a dunnage unit 42. In some examples, the end effector 64 includes a set of motors 100 connected to the base 92. The motors 100 may be at least indirectly connected to the arms 98 and may drive the rotational movement of an arm 98 relative to a respective leg 94 about an axis extending in the Y-direction and/or the translational movement of a respective leg 94 in the Y-direction relative to the base 92.

In some instances, an arm 98 defines an angle of ninety degrees relative to a respective leg 94 when in the open configuration. An arm 98 may define an angle of less than ninety degrees relative to a respective leg 94 when in the closed configuration. While the end effector 64 is generally shown and described herein as including four legs 94 and four arms 98, the end effector 64 may include more or less than four legs 94 and four arms 98 within the scope of the present disclosure.

In various implementations, the controller is connected (e.g., electrically and/or wirelessly) to the first motor assembly 62-1, the second motor assembly 62-2, the third motor assembly 62-3, and/or the end effector 64, among others. In some example configurations, a wiring assembly (not depicted) that electrically connects the end effector 64 to the controller may be at least partially disposed in the structure 90.

In various implementations, the controller controls the operation and/or movement of the first motor assembly 62-1, the second motor assembly 62-2, the third motor assembly 62-3, and/or the end effector 64. For example, the controller may control the first motor assembly 62-1 and the second motor assembly 62-2 to move the track 60 relative to the frame 12 (e.g., in the Y-direction). The controller may control the third motor assembly 62-3 to move the third motor assembly 62-3 along the track 60 (e.g., in the X-direction). The controller may control the third motor assembly 62-3 and/or the end effector 64 to move the end effector relative to the track 60 (e.g., in the Z-direction). The controller may individually control each of the arms 98-1, 98-2, 98-3, and 98-4 of the end effector 64 to move them (i.e., rotate each of the arms 98-1, 98-2, 98-3, and 98-4 above the Y-axis) relative to their respective legs 94-1, 94-2, 94-3, and 94-4, for example, between an open configuration and a closed configuration. In some implementations, the controller rotates each arm 98-1, 98-2, 98-3, and 98-4 independently of each other arm.

In various implementations, the controller includes an electronic controller and/or an electronic processor, such as a programmable microprocessor and/or microcontroller. The controller may include an application specific integrated circuit (ASIC). The controller may include a central processing unit (CPU), a memory (for example, a non-transitory computer-readable storage medium), and/or an input/output (I/O) interface. The controller may perform various functions, including those described in greater detail herein, with appropriate programming instructions and/or code embodied in software, hardware, and/or other medium. The controller may include a plurality of controllers. The controller may be connected to a display, such as a touch screen.

### Rope System

With reference to FIGS. 1, 4G, and 4L, in various implementations, the rope system 16 includes a first bracket 110-1, a second bracket 110-2, a third bracket 110-3, a first pulley 112-1, a second pulley 112-2, a set of ropes 114, at least one motor 116, a platform 118, and a set of sharp protrusions 120 (e.g., nails, etc.).

In various implementations, a bracket 110-1, 110-2, 110-3 comprises one or more of a variety of shapes, sizes, configurations, and/or materials. In some example configurations, the first, second, and third brackets 110-1, 110-2, 110-3 are connected to the frame 12. In some instances, the first bracket 110-1 is disposed proximate a first end 122-1 of the frame 12 and the second bracket 110-2 is disposed proximate a second end 122-2 of the frame 12 such that the rope system 16 spans the entire length of the frame 12. In various implementations, the third bracket 110-3 is disposed above the first bracket 110-1 (see, e.g., FIG. 4L).

In various implementations, the first pulley 112-1 is connected to the first bracket 110-1 and the second pulley 112-2 is connected to the second bracket 110-2. In various implementations, at least one rope 124-1 of the set of ropes 114 is connected to the first pulley 112-1 and the second pulley 112-2. The motor 116 may be connected to at least of one of the first pulley 112-1 or the second pulley 112-2. The motor 116 may be electrically connected to the controller. The controller may control operation of the motor 116.

In various implementations, a subset 124-2 of the set of ropes 114 is connected to the third bracket 110-3 at the first end 122-1 of the frame 12. The subset of ropes 124-2 may be connected to the second bracket 110-2 at the second end 122-2 of the frame 12. In some example configurations, the subset of ropes 124-4 define an angle 126 (e.g., greater than zero degrees) relative to the at least one rope 124-1 connected to first and second pulleys 112-1, 112-4 proximate the first end 122-1 of the frame 12 (see, e.g., FIG. 4L).

In various implementations, the platform 118 comprises one or more of a variety of shapes, sizes, configurations, and/or materials. The platform 118 may be connected to the rope 124-1 that is connected to the first and second pulleys 112-1, 112-2. In various implementations, the protrusions 120 is connected to the platform 118 and may extend from the platform 118 in the Z-direction. In various implementations, the motor 116 drives movement of the platform 118 such that the platform 118 moves (e.g., in the Y-direction) along the length of the frame 12. The controller may control the movement of the platform 118. In various implementations, the platform 118 and the set of protrusions 120 releasably connect with first and second outer layers 52-1, 52-1 of the set of dunnage units 42.

With reference to FIGS. 1 and 4M, a portion of the rope system 16 is disposed above a recycling system 22. In various implementations, the rope system 16 operates as a conveyor. For example, the rope system 16 transports first and second outer layers 52-1, 52-2 to a recycling system 22 such that the first and second outer layers 52-1, 52-2 can be recycled.

### Operation of System

FIG. 4A-4R illustrate example operations of the dunnage separation system 10. Referring now to FIG. 4A, in various implementations, the end effector 64 moves to engage a dunnage unit 42. When the end effector 64 engages the unit 42, the arms 98-1, 98-2, 98-3, 98-4 may be in the open configuration. In some instances, the legs 94-1, 94-2, 94-3, 94-4 of the end effector 64 may contact the unit 42 (e.g., the second outer layer 52-2), while the arms 98-1, 98-2, 98-3, 98-4 do not engage the unit 42. In some instances, the legs 94-1, 94-2, 94-3, 94-4 and/or arms 98-1, 98-2, 98-3, 98-4 may translate relative to one another and/or the base 92 in the Y-direction such that the distance (e.g., in the Y-direction) between the arm 94-1 and the arm 94-2 is greater than the width (e.g., in the Y-direction) of the inner layer 50.

In various implementations, subsequent to the end effector 64 engaging the unit 42, the arms 98-1, 98-2, 98-3, 98-4 are moved to a closed configuration. For example, the arms 98-1, 98-2, 98-3, 98-4 may pivot to contact the unit 42 (e.g., the first outer layer 52-1). As illustrated in FIG. 4A, when the arms are in the closed configuration, the unit 42 is secured to the end effector 64.

With reference to FIGS. 4B and 4C, the unit 42 may be secured to the end effector 64 such that portions of the first and second outer layers 52-1, 52-2 are disposed between the first leg 94-1 and the first arm 98-1 and between the second leg 94-1 and the second arm 98-2. Portions of the inner layer 50, the first outer layer 52-1, and the second outer layer 52-2 may be disposed between the third leg 94-3 and the third arm 98-1 and between the fourth leg 94-4 and the fourth arm 98-4.

In various implementations, the first leg 94-1 and the first arm 98-1 releasably hold a first edge 130-1 of the unit 42 and the second leg 94-1 and the second arm 98-1 releasably hold a second edge 130-2 of the unit 42. The first and second edges 130-1, 130-2 may include the first and second outer layers 52-1, 52-2. In various implementations, the third leg 94-3 in connection with the third arm 98-3 and the fourth leg 94-4 in connection with the fourth arm 98-4 releasably hold a middle portion 132 of the unit 42. The middle portion 132 may include the inner layer 50, the first outer layer 52-1, and the second outer layer 52-2.

Referring now to FIG. 4B, in various implementations, the end effector 64 moves (e.g., in the X-direction) to remove the unit 42 from one or more goods 40. In response to the unit 42 being removed from the goods 40, gravity may cause the second outer layer 52-2 to separate from the inner layer 50.

With reference to FIGS. 4D, 4E, and 4F, in various implementations, the end effector 64 places the unit 42 (e.g., the inner layer 50 and the first outer layer 52-1 onto a staging system 20 (e.g., a rack, etc.). Subsequent to the unit 42 being placed onto the staging system 20, the third arm 94-3 and the fourth arm 94-3 may be moved to the open configuration such that the inner layer 50 is no longer secured to the end effector 64. The first arm 94-1 and the second arm 94-2 may remain in the closed configuration such that the first and second layers 52-1, 52-2 remain secured to the end effector 64. In various implementations, the end effector 64 then moves (e.g., in the X-direction) such that the inner layer 50 remains on the staging system 20, while the first and second outer layers 52-1, 52-1 remain secured to the end effector 64.

With reference to FIGS. 4G and 4H, in various implementations, the end effector 64 transports the first and second outer layers 52-1, 52-2 to the rope system 16. The end effector 64 may place the first and second outer layers 52-1, 52-2 onto the protrusions 120 and the platform 118.

With reference to FIGS. 4I and 4J, in various implementations, the end effector 64 secures the first and second outer layers 52-1, 52-2 to the protrusions 120 and the platform 118. For example, the end effector 64 moves (e.g., in the Z-direction) such that the protrusions 120 pierce through the first and second outer layers 52-1, 52-2. In various implementations, subsequent to the first and second outer layers 52-1, 52-2 being secured to the protrusions 120 and the platform 118, the third and fourth arms 98-3, 98-4 are moved to the open configuration such that the first and second outer layers 52-1, 52-2 are no longer secured to the end effector 64.

With reference to FIG. 4K, in some instances, the end effector 64 manipulates the first and second outer layers 52-1, 52-2 such that the layers are ready to be transported by the rope system 16. For example, the end effector 64 wraps portions of the first and second outer layers 52-1, 52-2 around the platform 118.

With reference to FIGS. 4L and 4M, in various implementations, the rope system 16 moves (e.g., in the Y-direction) the first and second outer layers 52-1, 52-2 to a recycling system 22. In various implementations, in response to the first and second outer layers 52-1, 52-2 approaching the first end 122-1 of the frame 12, the rope system 16 automatically detaches the layers 52-1, 52-2 from the protrusions 120 and the platform 118. The detached layers 52-1, 52-2 may automatically drop into the recycling system 22. For example, the first and second outer layers 52-1, 52-2 detach from the protrusions 120 and the platform 118 by moving along the subset of ropes 124-2 that are attached to the third bracket 110-3, while the platform 118 and protrusions 120 continue moving with the rope 124-1 attached to the first and second pulleys 112-1, 112-2.

With reference to FIG. 4N, in various implementations, subsequent to the dunnage unit 42 being removed from one or more goods 40, the end effector 64 picks up exposed goods 40 and transports the goods to a conveyor and/or a staging system 20. For example, the first leg 94-1 in connection with the third leg 94-3 releasably holds a first good 40-1 and the second leg 94-2 in connection with the fourth leg 94-4 releasably holds a second good 40-2 such that the first and second goods 40-1, 40-2 can be moved by the end effector 64 to the conveyor 18 and/or to the staging system 20.

In various implementations, the above operations of the dunnage separation system 10 may be repeated for additional units of the set of dunnage units 42 so that used inner layers 50 may be disposed at a staging system 20 and used first and second outer layers 52-1, 52-2 may be disposed in a recycling system 22.

With reference to FIGS. 4O and 4P, in various implementations, the machine 24 moves the collected inner layers 50 from the used dunnage units 42 to an additional staging system 20 (e.g., a pallet, etc.). The machine 24 may dispose (e.g., stack) the inner layers 50 onto the staging system 20. Subsequently, the machine 24 may move the staging system 20 and the inner layers 50 to a determined location such that the inner layers can undergo additional operations (e.g., be reused for new dunnage units).

With reference to FIGS. 4Q and 4R, in various implementations, the end effector 64 is connected to an end effector system 14a (e.g., a robot having a plurality of translatable, extendable, rotatable, etc. arms). The end effector system 14a may be disposed adjacent to a conveyor 18 and a staging system 20a. The staging system 20a may include a lift 140 and one or more carts 142 (e.g., motorized carts). The lift 140 may include a frame 144 and a first arm 146a and a second arm 146b moveably (e.g., translatably) coupled to the frame 146. Goods 40 and dunnage units 42 may be disposed on the cart 142.

The first and second arms 146a, 146b may be moved so that they are disposed above the goods 40 and dunnage units 42. The end effector system 14a and end effector 64 may place each of the goods 40 on the conveyor 18 and the dunnage units on the first and second arms 146a, 146b. In response to all of the goods being placed on the conveyor 18 and all of the dunnage units 42 being placed on the arms 146a, 146b, the arms 146a, 146b may be lowered so that the dunnage units 42 are disposed on a cart 142. Subsequently, the cart 142 may move, for example, to a recycling center 22.

### Flowcharts

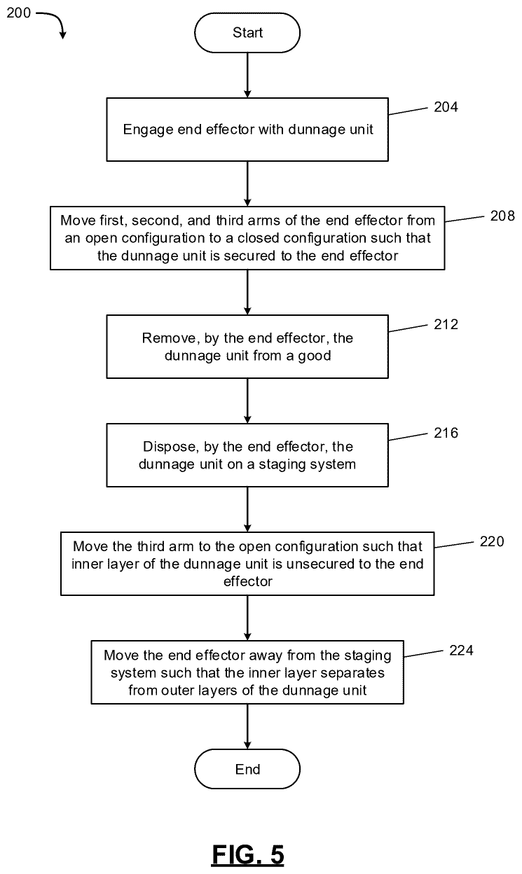

FIG. 5 is an example method 200 for operating an end effector 64. The method 200 may begin at 204. At 204, the end effector 64 may engage a dunnage unit 42. The dunnage unit 42 may be disposed on a good 40. The dunnage unit may include an inner layer 50 disposed between two outer layers 52-1, 52-2. The method 200 may proceed to 208.

At 208, a first arm 98-1, a second arm 98-2, and a third arm 98-3 of the end effector 64 may be moved from an open configuration to a closed configuration such that the dunnage unit 42 is secured to the end effector 64. Then the method 200 may proceed to 212.

At 212, the end effector 64 may remove the dunnage unit 42 from the good 40. Then the method 200 may proceed to 216. At 216, the end effector 64 may dispose the dunnage unit 42 on a staging system 20. Then the method 200 may proceed to 220.

At 220, the third arm 98-3 may move to the open configuration such that the inner layer 50 is unsecured to the end effector 64. Then the method 200 may proceed to 224. At 224, the end effector 64 may move away from the staging system 20 such that the inner layer 50 separates from the outer layers 52-1, 52-2. For example, the inner layer 50 remains on the staging system 20, while the outer layers 52-1, 52-2 remain secured to the end effector 64. Then the method 200 may end.

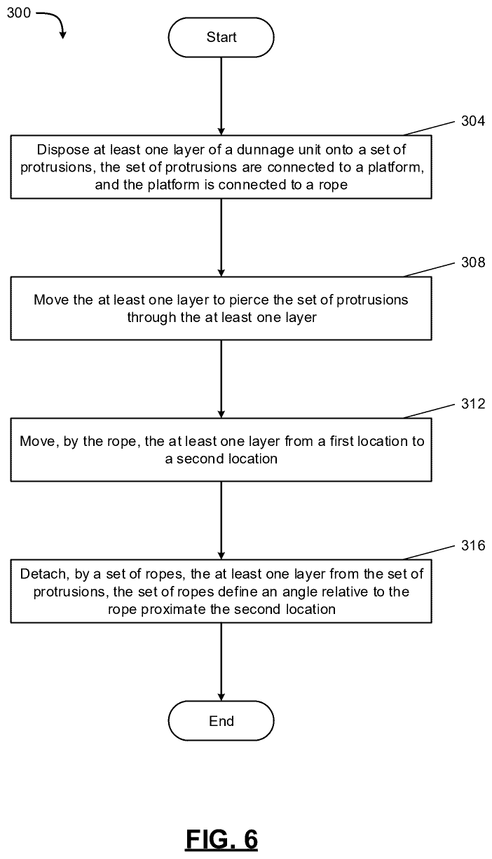

FIG. 6 is an example method 300 for operating a rope system 16. The method 300 may begin at 304. At 304, an end effector 64 may dispose at least one layer 52-1, 52-2 of a dunnage unit 42 onto a set of protrusions 120. The set of protrusions 120 may be connected to a platform 118. The platform 118 may be connected to a rope 124-1. The method 300 may proceed to 308.

At 308, the end effector 64 may move the at least one layer 52-1, 52-2 to pierce the set of protrusions 120 through the at least one layer 52-1, 52-2. The method 300 may proceed to 312.

At 312, the rope 124-1 may move the at least one layer 52-1, 52-2 from a first location (e.g., a location disposed proximate a staging system 20, among others) to a second location (e.g., a location disposed proximate a recycling system 22, among others). Then the method 300 may proceed to 316. At 316, a set of ropes 124-2 may detach the at least one layer 52-1, 52-2 from the set of protrusions 120. The set of ropes 124-2 may define an angle 126 relative to the rope 124-1 proximate the second location. Then the method 300 may end.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” The use of the word “proximate” may mean near, close to, or closer to one (e.g., a first end) than another (e.g., a second end that is opposite the first end). Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a dunnage separation system and related methods, as described above.

Clause 1: An end effector comprising: a base; a first leg connected to the base; a second leg connected to the base and offset from the first leg; a first arm pivotably connected to the first leg; and a second arm pivotably connected to the second leg, wherein the first leg and the first arm are configured to releasably hold a first portion of a dunnage unit, and wherein the second leg and the second arm are configured to releasably hold a second portion of the dunnage unit.

Clause 2: The end effector of clause 1, further comprising: a third leg connected to the base and disposed between the first and second legs; and a third arm pivotably connected to the third leg, wherein the third leg and the third arm are configured to releasably hold a third portion of the dunnage unit.

Clause 3: The end effector of clause 2, wherein: the dunnage unit includes: an inner layer; a first outer layer; and a second outer layer; the inner layer is disposed between the first and second outer layers; the first and second portions of the dunnage unit includes portions of the first and second outer layers; and the third portion of the dunnage unit includes portions of the inner layer, the first outer layer, and the second outer layer.

Clause 4: The end effector of clause 3, wherein the end effector is configured to separate the first and second outer layers from the inner layer.

Clause 5: The end effector of any of clauses 2 through 4 further comprising: a fourth leg connected to the base and disposed adjacent to the third leg; and a fourth arm pivotably connected to the fourth leg, wherein the fourth arm is configured to move independently from the third arm.

Clause 6: The end effector of clause 5 wherein: the first leg and the third leg are configured to releasably hold a first good, and the second leg and the fourth leg are configured to releasably hold a second good.

Clause 7: The end effector of clause 6 wherein at least one of the first good or the second good is a wheel.

Clause 8: The end effector of any of clauses 1 through 7, wherein the first leg is translatably-coupled to the base.

Clause 9: A machine comprising: the end effector of any of clauses 1 through 8.

Clause 10: The machine of clause 9 wherein the machine includes a track and a bracket translatably-coupled to the track, and wherein the end effector is coupled to the bracket.

Clause 11: The machine of clause 9 wherein the machine is a robot, and wherein the end effector is coupled to the bracket.

Clause 12: A method for operating an end effector, the method comprising: engaging the end effector with a dunnage unit, wherein the dunnage unit is disposed on a good, and wherein the dunnage unit includes an inner layer disposed between two outer layers; moving a first arm, a second arm, and a third arm of the end effector from an open configuration to a closed configuration such that the dunnage unit is secured to the end effector; removing, by the end effector, the dunnage unit from the good; disposing, by the end effector, the dunnage unit on a staging system; moving the third arm to the open configuration such that the inner layer is unsecured to the end effector; and moving the end effector away from the staging system such that the inner layer separates from the outer layers.

Clause 13: The method of clause 12 wherein the end effector includes a first leg, a second leg, and a third leg.

Clause 14: The method of clause 13 wherein: the first arm is pivotably connected to the first leg, the second arm is pivotably connected to the second leg, and the third arm is pivotably connected to the third leg.

Clause 15: The method of any of clauses 12 through 14 wherein: the end effector includes a first leg, the first arm is pivotably connected to the first leg, in response to being in the open configuration, the first arm is disposed at a first angle relative to the first leg, and in response to being in the closed configuration, the first arm is disposed at a second angle relative to the first leg.

Clause 16: The method of clause 15 wherein the second angle is less than the first angle.

Clause 17: The method of any of clauses 15 through 16 wherein: the first angle is ninety degrees, and the second angle is less than ninety degrees.

Clause 18: The method of any of clauses 12 through 17 further comprising: disposing, by the end effector, a set of goods on a conveyor; and stacking, by the end effector, a set of dunnage units on arms of a lift.

Clause 19: The method of clause 18 wherein: prior to being moved, the set of goods and the set of dunnage units are disposed on a cart, and stacking the set of dunnage units on the arms includes moving, by the end effector, the set of dunnage units from the cart to the arms disposed above the cart.

Clause 20: The method of clause 19 wherein, in response to each good of the set of goods being removed from the cart, the arms are lowered to dispose only the set of dunnage units on the cart.

Clause 21: A rope system comprising: a set of ropes each having a first end and a second end and configured to support a dunnage unit, the first end connected to a first end of a frame, the second end connected to a second end of the frame; and a platform having at least a portion protruding from the set of ropes and configured to move between the first end of the frame and the second end of the frame, wherein the rope system is configured to move the dunnage unit from a first location to a second location.

Clause 22: The rope system of clause 21, further comprising a bracket connected the first end of the frame and disposed above the first end of the frame, wherein the set of ropes is connected to the bracket and the second end of the frame.

Clause 23: The rope system of clause 22, wherein the set of ropes define an angle relative to the platform proximate the first end of the frame.

Clause 24: The rope system of any of clauses 21 through 23, wherein the platform includes a set of protrusions configured to releasably engage the dunnage unit.

Clause 25: The rope system of clause 24, wherein the set of ropes are configured to detach the dunnage unit from the set of protrusions.

Clause 26: A method for operating a rope system, the method comprising: disposing a dunnage unit onto a platform and a set of ropes, moving, by the platform, the dunnage unit from a first location to a second location along the set of ropes; and detaching, by the set of ropes, the dunnage unit from the platform, wherein the set of ropes define an angle relative to the platform proximate the second location.

1. An end effector comprising:
a base;
a first leg connected to the base;
a second leg connected to the base and offset from the first leg;
a first arm pivotably connected to the first leg; and
a second arm pivotably connected to the second leg,
wherein the first leg and the first arm are configured to releasably hold a first portion of a dunnage unit, and
wherein the second leg and the second arm are configured to releasably hold a second portion of the dunnage unit.

2. The end effector of claim 1 further comprising:
a third leg connected to the base and disposed between the first and second legs; and
a third arm pivotably connected to the third leg,
wherein the third leg and the third arm are configured to releasably hold a third portion of the dunnage unit.

3. The end effector of claim 2 wherein:
the dunnage unit includes:
an inner layer;
a first outer layer; and
a second outer layer;
the inner layer is disposed between the first and second outer layers;
the first and second portions of the dunnage unit includes portions of the first and second outer layers;
the third portion of the dunnage unit includes portions of the inner layer, the first outer layer, and the second outer layer, and
the end effector is configured to separate the first and second outer layers from the inner layer.

4. The end effector of claim 2 further comprising:
a fourth leg connected to the base and disposed adjacent to the third leg; and
a fourth arm pivotably connected to the fourth leg,
wherein the fourth arm is configured to move independently from the third arm.

5. The end effector of claim 4 wherein:
the first leg and the third leg are configured to releasably hold a first good, and
the second leg and the fourth leg are configured to releasably hold a second good.

6. The end effector of claim 1 wherein the first leg is translatably-coupled to the base.

7. A machine comprising:
the end effector of claim 1.

8. The machine of claim 7 wherein the machine includes a track and a bracket translatably-coupled to the track, and wherein the end effector is coupled to the bracket.

9. The machine of claim 8 wherein the machine is a robot, and wherein the end effector is coupled to the bracket.

10. A method for operating an end effector, the method comprising:
engaging the end effector with a dunnage unit,
wherein the dunnage unit is disposed on a good, and
wherein the dunnage unit includes an inner layer disposed between two outer layers;
moving a first arm, a second arm, and a third arm of the end effector from an open configuration to a closed configuration such that the dunnage unit is secured to the end effector;
removing, by the end effector, the dunnage unit from the good;
disposing, by the end effector, the dunnage unit on a staging system;
moving the third arm to the open configuration such that the inner layer is unsecured to the end effector; and
moving the end effector away from the staging system such that the inner layer separates from the outer layers.

11. The method of claim 10 wherein the end effector includes a first leg, a second leg, and a third leg.

12. The method of claim 11 wherein:
the first arm is pivotably connected to the first leg,
the second arm is pivotably connected to the second leg, and
the third arm is pivotably connected to the third leg.

13. The method of claim 10 wherein:
the end effector includes a first leg,
the first arm is pivotably connected to the first leg,
in response to being in the open configuration, the first arm is disposed at a first angle relative to the first leg, and
in response to being in the closed configuration, the first arm is disposed at a second angle relative to the first leg.

14. The method of claim 13 wherein the second angle is less than the first angle.

15. The method of claim 10 further comprising:
disposing, by the end effector, a set of goods on a conveyor; and
stacking, by the end effector, a set of dunnage units on arms of a lift.

16. The method of claim 15 wherein:
prior to being moved, the set of goods and the set of dunnage units are disposed on a cart, and
stacking the set of dunnage units on the arms includes moving, by the end effector, the set of dunnage units from the cart to the arms disposed above the cart.

17. A rope system comprising:
a set of ropes each having a first end and a second end and configured to support a dunnage unit, the first end connected to a first end of a frame, the second end connected to a second end of the frame; and
a platform having at least a portion protruding from the set of ropes and configured to move between the first end of the frame and the second end of the frame,
wherein the rope system is configured to move the dunnage unit from a first location to a second location.

18. The rope system of claim 17 further comprising a bracket connected the first end of the frame and disposed above the first end of the frame, wherein the set of ropes is connected to the bracket and the second end of the frame.

19. The rope system of claim 18 wherein the set of ropes define an angle relative to the platform proximate the first end of the frame.

20. The rope system of claim 17 wherein the platform includes a set of protrusions configured to releasably engage the dunnage unit.

21. The rope system of claim 20 wherein the set of ropes are configured to detach the dunnage unit from the set of protrusions.

22. A method for operating a rope system, the method comprising:
disposing a dunnage unit onto a platform and a set of ropes,
moving, by the platform, the dunnage unit from a first location to a second location along the set of ropes; and
detaching, by the set of ropes, the dunnage unit from the platform, wherein the set of ropes define an angle relative to the platform proximate the second location.
